(19) United States
(12) Patent Application Publication
(10) Pub. No.: US 2016/0359633 A1
(43) Pub. Date: Dec. 8, 2016

(54) SYSTEM AND METHOD FOR PUBLICLY CERTIFYING DATA

(71) Applicant: Crater Dog Technologies, LLC, Louisville, CO (US)

(72) Inventor: Derk Norton, Louisville, CO (US)

(21) Appl. No.: 15/171,321

(22) Filed: Jun. 2, 2016

Related U.S. Application Data
(60) Provisional application No. 62/169,794, filed on Jun. 2, 2015.

(51) Int. Cl. H04L 9/32; H04L 9/30; H04L 9/14

(52) U.S. Cl. CPC H04L 9/3247; H04L 9/14; H04L 9/30; H04L 2209/24; H04L 2209/72

(57) ABSTRACT

Systems and methods are provided for certifying digital tokens and digital transactions that transfer certified digital tokens from one party to another party. Multiple parties such as electronic devices may exchange digital tokens and digital transactions using public key cryptography, which means that each party has a private key that is used to digitally sign a digital token or digital transaction and a public key that is used to verify the signature. After mutual verification, the signed digital tokens and signed digital transactions may be sent to various registries that verify aspects of the tokens, transactions, and related signatures before publicly publishing the signed digital tokens and signed digital transactions such that no party may later repudiate the signed digital tokens, the signed digital transactions, or parties that signed them.

### CROSS-REFERENCE TO RELATED APPLICATIONS

This application claims the benefit of U.S. Provisional Patent Application Ser. No. 62/169,794, filed Jun. 2, 2015, the entire disclosure of which is hereby incorporated herein by reference.

### FIELD

The invention relates to public-key cryptography and digital signatures. More particularly, the invention relates to systems and methods that publicly certify data and provide authentication and non-repudiation functions.

### BACKGROUND

Public-key cryptography is a type of cryptography that utilizes two keys to encrypt data or digitally sign data. The first key is a public key that is associated with a known party, and the public key is available to the public or otherwise available to relevant parties. The second key is a private key that is kept secret by the party. These two keys are mathematically linked to each other such that it is relatively easy to calculate the public key from the private key but nearly impossible to calculate the private key from the public key. Therefore, for example, a party that receives data signed with a private key may verify the signature with the related public key. However, it is nearly impossible to derive the private key from the public key and then “forge” signatures on data using the private key. Early examples of public key cryptosystems include RSA and Diffie-Hellman.

While it may be nearly impossible to calculate a private key from a public key, private keys are still susceptible to conventional means of hacking or theft. Another challenge with public-key cryptography is the verification of a public key owner's identity. A common mechanism that is used to verify a public key owner's identity is a public key infrastructure that is operated by a trusted certificate authority. A registration or issuance process binds a public key to its owner. The public key-owner information is stored in a central directory. Then, a party may send the public key over a network to a validation authority associated with the certificate authority and the central directory. The validation authority accesses information in the central directory and confirms the identity of the public key's owner. Examples of certificate authorities include Verisign, Comdo, Symantec Group, Go Daddy Group, and GlobalSign. A specific example of a public key infrastructure is found in U.S. Pat. No. 7,840,804, which is incorporated herein in its entirety by reference.

A different but related issue is certifying the actual content of the data being exchanged and not just the source of the private key signature. Encryption protocols, including public-key encryption, ensure confidentiality of the data being transmitted across a network such as the Internet. However, encryption tools do not guarantee that the content of the data is correct, or that any other portions or steps in inter-computer communications or transactions are being performed. For example, in a contract or other quid pro quo scenario between two parties, a party needs assurance that the other party will exchange the correct data, data content, and/or perform any other steps in the communication or transaction. Otherwise, the two parties are in a stalemate, and each party must rely on the good faith of the other party that the content of the data is correct and that other portions or steps in the communication or transaction will be performed. Such reliance is not ideal, especially between parties that have had no previous interaction with each other and have no information regarding the reputation of the other party. Therefore, there is a need for a system and method for publicly certifying data such that no parties may later repudiate the content of the data.

### SUMMARY

Embodiments of the invention ensure the content of exchanged data is correct by publicly certifying all or some of the content of the data. In some embodiments, a token registry may be utilized to certify data. Parties, for example electronic devices, may send data over a network to the token registry, which verifies the private keys of the parties and the content or attributes of the data. Then, the token registry may publicly publish all or some of the content. Publication may mean placing the content of the data onto a server or other computer device with an Internet Protocol (IP) address and/or a uniform resource locator (URL) such that any electronic device or member of the public may access the content of the data. It will be appreciated that publication may include instances where the data is published to a subset of any electronic device or member of the public. In some embodiments of the invention, the exchanged data is one or more digital tokens, which are created (minted), signed, and may represent guaranteed value.

It is an aspect of some embodiments of the invention to provide a system or method for certifying a signed digital token where a value guarantor and a digital mint each verify each other's identity and sign the digital token to certify it before publicly publishing the certified digital token. Using the public-key cryptography example, a value guarantor may sign a digital token with its private key and send the digital token over a network to a digital mint. The digital mint may verify the value guarantor's identity using the value guarantor's public key. This may require the use of a certificate authority or other similar institution. Then, the digital mint verifies the content of the digital token, signs the digital token using the digital mint's private key, and sends the signed digital token over a network back to the value guarantor. In some embodiments, the digital mint may sign the value guarantor's private key signature of the digital token. The value guarantor verifies the identity of the digital mint using the digital mint's public key, again, which may entail the use of a certificate authority. Then, the value guarantor verifies the content of the signed digital token to ensure that there has been no change in the content of the digital token. Next, the digital token having the private key signatures of both parties is sent over a network to a token registry. The token registry verifies both signatures on the signed digital token, validates the content of the digital token, then publicly publishes the certified digital token such that neither party may later repudiate its contents.

It is another aspect of some embodiments of the invention to provide a system or method for certifying data where one party controls the public certification of data or transactions. The parties may sign data using a private key and verify the signatures using the other parties' public key. But one party may control if and when the data and/or transaction details are publicly published. For example, once one party receives the correct data or steps of a transaction have been performed, the party may publish details of the transaction such that no party may later repudiate details of the transaction, similar to an escrow situation.

It is an aspect of embodiments of the invention to provide a system or method for certifying data where the data resides on a data registry. The parties, thus, do not have the ability to alter the data. Instead, the parties may retrieve a copy of the data from the data registry for inspection and verification. The token registry may be utilized in these embodiments to certify a transaction entry, for example, a transfer of ownership of the data on the data registry.

It is yet another aspect of embodiments of the invention to provide a system or method for certifying data where data is certified in multiple stages and/or by multiple certification registries. For example, a first token registry may certify and publish data and the content or attributes of the data, and a second token registry may certify and publish a transaction entry or that transfers ownership of the data.

It is another aspect of embodiments of the invention to provide a system or method for certifying data that relies on at least one electronic device to perform the system or method. For example, first and second parties may each be or operate an electronic device having a non-transitory computer-readable storage medium that is configured to store data, data attributes, public and/or private keys, etc. Examples of non-transitory computer-readable storage mediums may include volatile memory such as random access memory and non-volatile memory such as solid state drives or hard disk drives. An electronic device may also store application instructions for manipulating data and comprise an I/O port for communication with other electronic devices via a communication protocol.

Additional features and advantages of embodiments of the present disclosure will become more readily apparent from the following description, particularly when taken together with the accompanying drawings.

### BRIEF DESCRIPTION OF THE DRAWINGS

FIG. 1 is a sequence diagram depicting the minting and public certification of a digital token representing value that is guaranteed by a party in accordance with embodiments of the invention;

FIG. 2A is a sequence diagram depicting the creation and public certification of a digital transaction that transfers a certified digital token from one party (the current owner of the digital token) to another party (the new owner of the digital token) in accordance with embodiments of the invention;

FIG. 2B is a sequence diagram that is a variation on FIG. 2A that includes a third party that acts similar to an escrow account for the digital transaction in accordance with embodiments of the invention; and

FIG. 3 is a sequence diagram depicting the minting and public certification of a batch of digital tokens representing some arbitrary value that is guaranteed by a party where the party transfers a portion of the newly certified digital tokens to the party responsible for minting them in accordance with embodiments of the invention.

### DETAILED DESCRIPTION

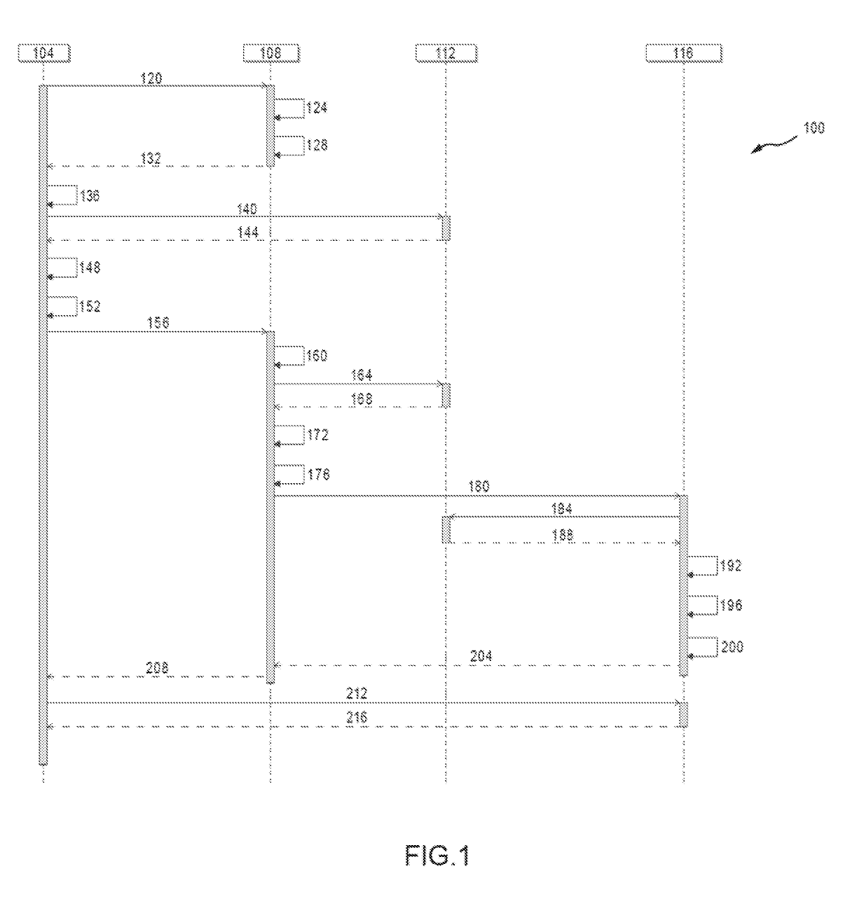

FIG. 1 depicts a sequence diagram of a system 100 that certifies the content of data such as a signed digital token so that parties may not alter or repudiate the content of the digital token after certification. A value guarantor 104, a digital mint 108, a key registry 112, and a token registry 116 are arranged across the top of the sequence diagram. The first party 104 is a guarantor of the value of data which may be represented as a certified digital token, and the second party 108 is a digital mint or other similar entity that creates and certifies the digital token. The value guarantor may be an institution such as a bank, airline, cellular company, merchant, church, etc. that backs or guarantees the value of the certified digital token, which may be data that has perceived value with a type (e.g., euro, bitcoin, frequent fly miles, cellular minutes, merchant specific points, bingo points, etc.) and denomination (e.g., 0.001, 1, 10, 25, 1000, etc.). The certification function of the embodiment in FIG. 1 prevents the forgery or theft of the data when represented as a certified digital token.

Each party 104, 108 has a private key and a public key, wherein the public key is used to verify the identity and signature of the user of the related private key. The public keys for each party 104, 108 are stored in a key registry 112 and are accessible by the public or a limited number of entities. The key registry 112 may refer to a validation authority or a certificate authority that registers public keys for an entity. The token registry 116 refers to an entity that receives data such as a signed digital token for publication, and certifies that the signatures on the digital token were generated by the parties 104, 108 using their respective private keys. Therefore, any party to the transaction cannot modify or repudiate the content of the certified digital token. It will be appreciated that some embodiments of the invention may include multiple types of registries for different purposes and sequences in an operation, different types of data, etc. For example, one token registry may certify and publish the signed digital tokens while another token registry may certify and publish the completed portions or steps of a transaction associated with a signed digital token.

The system's 100 first operation is a transaction request 120 from the value guarantor 104 to the digital mint 108. The digital mint 108 creates 124 a digital token containing the data as content with various additional attributes such as a time stamp, an expiration date, digital token type and denomination, the algorithm used for the private and public keys and the version of that algorithm, etc. A value guarantor 104 may request a digital token from a digital mint 108, and the digital mint 108 creates the digital token. Next, the digital mint 108 signs 128 the digital token using the digital mint's private key, and the digital mint 108 sends 132 the signed digital token to the value guarantor 104 so that the value guarantor 104 may verify 136 the content of the signed digital token using the public key for the digital mint 108.

Verification by the parties 104, 108 in FIG. 1, and other parties described below, may be accomplished by a computer system that compares a first data set to a second data set. For example, the value guarantor 104 may compare a first data set sent to the digital mint 108 with a second data set received from the digital mint 108 to verify the integrity of the data. In more sophisticated systems, a first hash may be generated to represent a first data set and a second hash may be generated to represent a second data set. Then, a computer system may compare the two sets of data by comparing the two hashes, which saves on computing resources because the computer system that compares the two hashes does not need to access the original data sets.

After verifying the signed digital token, the value guarantor 104 may then verify the identity of the digital mint 108. The value guarantor 104 requests 140 the digital mint's 108 public key from the key registry 112, and the key registry 112 sends 144 the digital mint's 108 public key to the value guarantor 104. The value guarantor 104 verifies 148 the digital mint's 108 private key signature on the signed digital token using the digital mint's 108 public key. Then the value guarantor 104 signs 152 the digital token using the value guarantor's 104 private key and sends 156 the digital token back to the digital mint 108.

Next, the digital mint 108 performs a similar series of verification steps. The digital mint 108 verifies 160 the content of the data to confirm that the value guarantor 104 has not altered the content of the data since the digital mint 108 first sent the data to the value guarantor 104. The digital mint 108 then requests 164 the value guarantor's public key from the key registry 112, which sends 168 the value guarantor's 104 public key to the digital mint 108. The digital mint 108 verifies 172 the value guarantor's 104 private key signature on the signed digital token using the value guarantor's 104 public key. The digital mint 108 signs 176 the digital token a second time using the digital mint's private key to certify it.

The certified digital token is sent 180 to a token registry 116 once both parties have verified each other's private keys. The token registry 116 requests 184 both parties' 104, 108 public keys from the key registry 112, which sends 188 the parties' 104, 108 public keys to the token registry 116. The token registry 116 verifies 192 the content of the certified digital token which may include the various timestamp, algorithms, and algorithm versions. Then, the token registry 116 verifies 196 all parties' private key signatures using the relevant public keys. After verifying the content of the certified digital token and the parties involved, the token registry 116 publicly publishes 200 the certified digital token.

After publication, the token registry 116 sends 204 the location of the published certified digital token to the digital mint 108. The location may be an internet protocol address or data content resource locator. The digital mint 108 sends 208 the location of the published certified digital token to the value guarantor 104. Then, the value guarantor 104 may request 212 the published certified digital token from the token registry 116, and the token registry 116 sends 216 the certified digital token to the value guarantor 104.

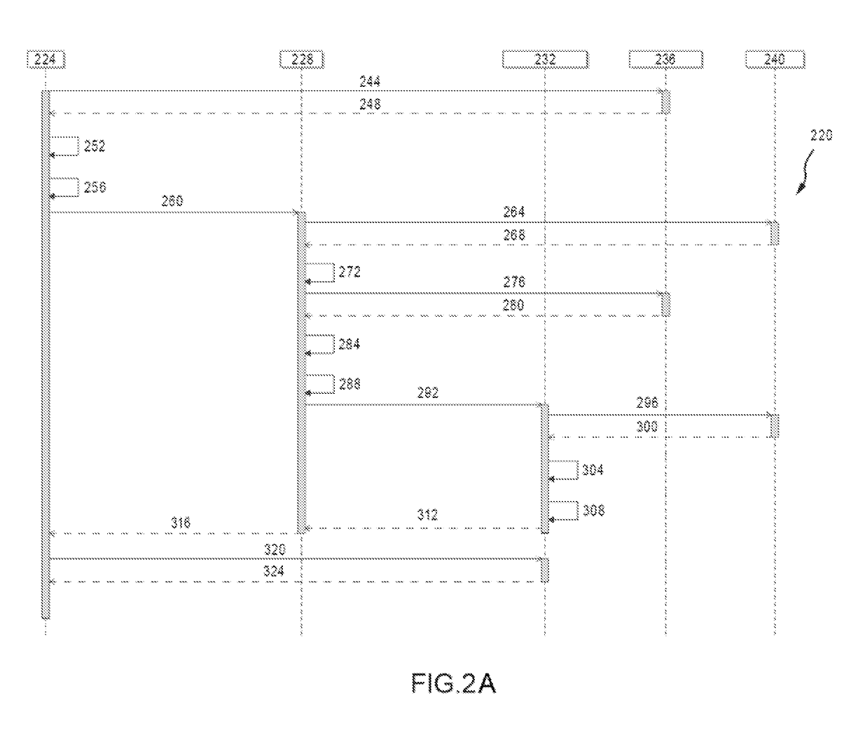

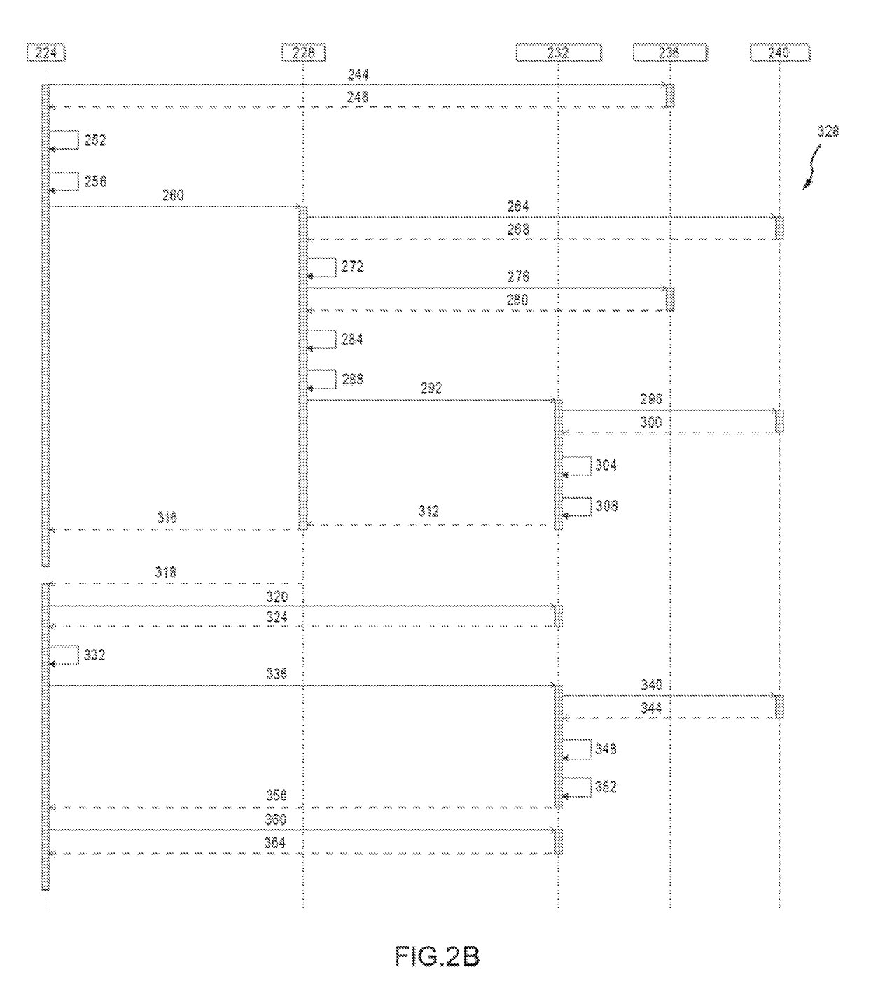

FIG. 2A depicts a sequence diagram of a system 220 that certifies a digital transaction entry on behalf of a sender 224. The sender 224, a receiver 228, a transaction registry 232, a token registry 236, and a key registry 240 are arranged across the top of the sequence diagram. The token registry 236 provides a location for the sender 224 and the receiver 228 to inspect and verify a certified digital token without possessing the token. As such, the transaction registry 232 may certify a digital transaction associated with a certified digital token, for example, the transfer of ownership of a certified digital token located in the token registry 236. Similar to the embodiment described in FIG. 1, the sender 224 and the receiver 228 each have a pair of public and private keys where the public keys reside in the key registry 240.

First, the sender 224 prompts the token registry 236 with a request 244 for a certified digital token that the sender 224 currently owns. The token registry 236 provides 248 a certified digital token to the sender 224. Next, the sender 224 creates 252 a digital transaction transferring ownership of the certified digital token to the receiver 228. Like certified digital tokens, a digital transaction may be signed with a private key and approved by various parties. The sender 224 signs 256 the digital transaction with the sender's 224 private key and then sends 260 the signed transaction to the receiver 228.

The receiver 228 requests 264 the sender's 224 public key from the key registry 240, which in turn sends 268 the sender's 224 public key to the receiver 228. The receiver 228 verifies 272 the sender's 224 private key signature using the sender's 224 public key. Then, the receiver 228 prompts the token registry 236 with a request 276 for the same certified digital token that the sender 224 requested. The token registry 236 provides 280 the requested certified digital token to the receiver 228. This gives the receiver 228 an opportunity to verify 284 the token's attributes, for example, ownership of the token. The receiver 228 then signs the digital transaction with the receiver's 228 private key, and the receiver 228 sends 292 the signed digital transaction to the transaction registry 232.

The transaction registry 232 requests 296 the sender's 224 and the receiver's 228 public keys from the key registry 240, which in turn sends 300 the sender's 224 and the receiver's 228 public keys to the transaction registry 232. The transaction registry 232 verifies 304 the sender's 224 and the receiver's 228 digital signatures on the digital transaction using the respective private keys. After verifying the parties' signatures, the transaction registry 232 publicly publishes 308 the signed digital transaction to certify it. In some embodiments, the transaction entry documents the ownership of certified digital tokens, and the publication 308 provides a record of a transfer in ownership such that no party may later repudiation the transfer.

The transaction registry 232 may then provide 312 the location of the publication to the receiver 228. The location of the publication may refer to the information that allows a member of the public at large or a member of a select group to access the certified transaction. The receiver 228 may pass 316 the location of the publication to the sender 224, who may then prompt the transaction registry 232 with a digital transaction request 320, and the transaction registry 232 may directly send 324 the published certified transaction to the sender 224.

FIG. 2B depicts a sequence diagram of a system 328 that is similar to the system 220 described in FIG. 2A. However, the transaction registry 232 may handle two separate certifications, or alternatively, a two-stage certification that comprises an initial approval from the receiver 228 and a final approval from the sender 224. A multiple-stage approval process of a digital transaction may provide flexibility for parties to craft a system or process that prevents theft and forgery.

Once the receiver 228 passes 316 the location of the publication to the sender 224, the receiver 228 may also deliver 318 a product, service, data, or other step in a transaction to the sender 224. To reflect this delivery, the sender 224 may approve the digital transaction. The sender 224 requests 320 the digital transaction from the transaction registry 232, which in turn sends 324 the digital transaction to the sender 224. The sender 224 signs 332 the digital transaction using the sender's 224 private key, and the sender 224 delivers 336 the digital transaction to the transaction registry 232.

The transaction registry 232 requests 340 the sender's 224 and the receiver's 228 public keys from the key registry 240, which in turn sends 344 the sender's 224 and the receiver's 228 public keys to the transaction registry 232. The transaction registry 232 verifies 348 the sender's 224 and the receiver's 228 digital signatures using the respective public keys. After verifying the parties' signatures, the transaction registry 232 publicly publishes 352 all or some of the transaction entry to certify the digital transaction. The transaction registry 232 may then provide 356 the location of the publication to the sender 224. The sender 224 may request 360 the digital transaction from the transaction registry 232, which may in turn send 364 the certified transaction to the sender 224.

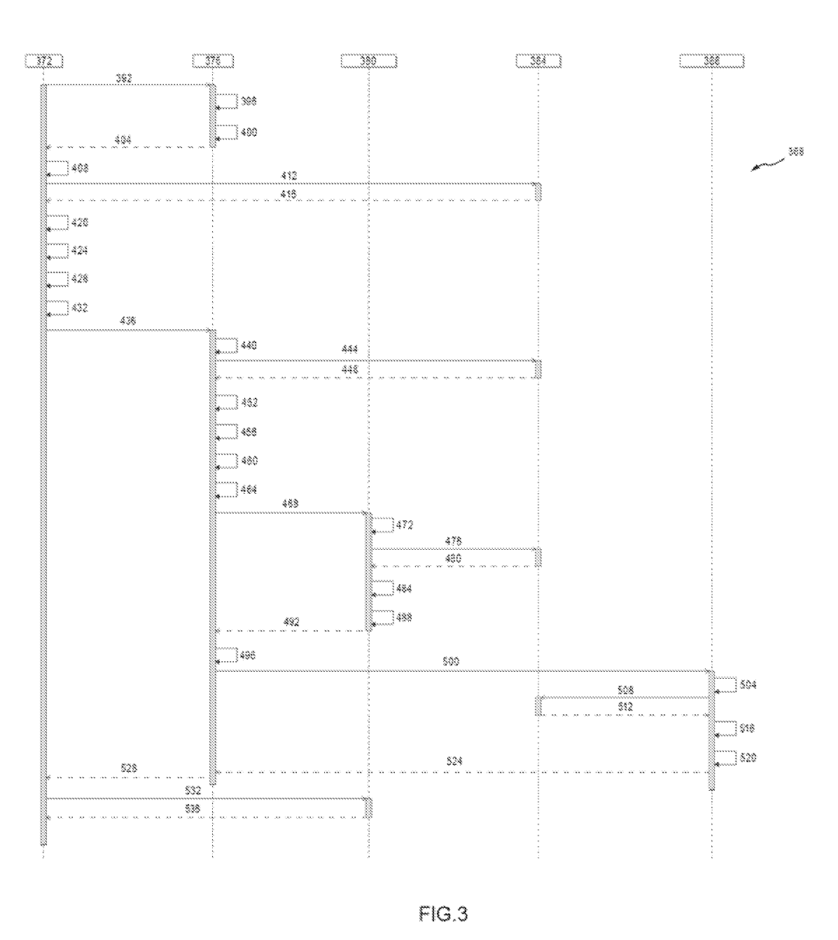

FIG. 3 depicts a sequence diagram of a system 368 that extends the embodiments of FIG. 1 by having the digital mint certify a batch of digital tokens for a value guarantor and as part of the process the value guarantor transfers ownership of a portion of the new digital tokens to the digital mint. A value guarantor 372, a digital mint 376, a token registry 380, a key registry 384, and a transaction registry 388 are arranged across the top of the sequence diagram. Certification and publication from the registries 380, 388 may be directed to different sets of recipients in various embodiments.

The value guarantor 372 requests 392 a batch of new digital tokens from the digital mint 376. The digital mint 376 creates 396 a batch of new digital tokens with content and various attributes such as a time stamp, an expiration date, the algorithm used for the private and public keys and the version of that algorithm, etc. Next, the digital mint 376 signs 400 the new digital tokens using the digital mint's private key, and the digital mint 376 sends 404 the new signed digital tokens to the value guarantor 372 so that the value guarantor 372 may verify 408 the content of the new digital tokens.

The value guarantor 372 requests 412 the digital mint's 376 public key from the key registry 384, and the key registry 384 sends 416 the digital mint's 376 public key to the value guarantor 372. The value guarantor 372 verifies 420 the digital mint's 376 private key signature using the digital mint's 376 public key. Then the value guarantor 372 signs 424 the new digital tokens using the value guarantor's 372 private key. Then, the value guarantor 372 creates 428 a set of digital transactions transferring a portion of the new digital tokens to the digital mint 376, and the value guarantor 372 signs 432 the new digital transactions using the value guarantor's 372 private key.

In some embodiments, the portion of new digital tokens to be transferred to the digital mint 376 by the value guarantor 372 may be calculated as a percentage of the total digital tokens in the batch, and/or a fixed number of digital tokens. The formula for this calculation may be agreed upon between the value guarantor 372 and the digital mint 376 beforehand or at the time of the request.

The value guarantor 372 sends 436 both the newly signed batch of digital tokens and the signed digital transactions to the digital mint 376 where the digital mint 376 may verify 440 the attributes of the digital transactions. The digital mint 376 may then request 444 the value guarantor's 372 public key from the key registry 384, which in turn delivers 448 the value guarantor's 372 public key to the digital mint 376. Then, the digital mint 376 may verify 452 the value guarantor's 372 signatures on the digital transactions, verify 456 the content of the digital tokens, and verify 460 the value guarantor's 372 signatures on the digital tokens. Having verified both the new digital tokens and digital transactions, the digital mint 372 may sign 464 the batch of digital tokens using the digital mint's 376 private key and send 468 the batch of signed digital tokens to the token registry 380.

The token registry 380 verifies 472 the content of the signed digital tokens. Then, the token registry 380 requests 476 both parties' 372, 376 public keys from the key registry 384, which sends 480 the parties' 372, 376 public keys to the token registry 380. The token registry 380 verifies 484 all parties' private key signatures using the associated public keys. After verifying the content of the signed digital tokens and the parties involved, the token registry 380 publicly publishes 488 the now certified digital tokens such that neither party may later repudiate their content.

The token registry 380 sends 492 the location of the publication such as a URL address to the digital mint 376. Then, the digital mint 376 may sign 496 the digital transactions using the digital mint's 376 private key, and the digital mint 376 may send 500 the signed digital transactions to the transaction registry 388. The transaction registry 388 may then verify 504 the content of the signed digital transactions. The transaction registry 388 may request 508 both parties' 372, 376 public keys from the key registry 384, which sends 512 the parties' 372, 376 public keys to the transaction registry 388. The transaction registry 388 verifies 516 all parties' private key signatures using the associated public keys. After verifying the content of the signed digital transactions and the parties involved, the transaction registry 388 publicly publishes 520 the signed digital transactions such that neither party may later repudiate the content of the signed digital transactions. This ensures that the value guarantor has transferred ownership of the partial set of certified digital tokens to the digital mint.

The transaction registry 388 returns 524 the location of the signed digital transactions publication to the digital mint 376, which may then return 528 the location of the publication to the value guarantor 372. The value guarantor 372 may then request 532 the newly certified digital tokens from the token registry 380, which may then send 536 the certified digital tokens to the value guarantor 372.

Generally, certification allows parties to document some or all of the content of the data like a ledger, which maintains the security of the transaction and prevents theft. Further, it will be appreciated that not all of the content of the data needs to be certified and published. For example, in a contract negotiation, one party may be obligated to perform an action, which would be part of the content of the data being exchanged between parties. Further, another party may be obligated to produce payment for the performance of an action. However, both parties may agree to keep the payment terms of the agreement confidential while agreeing to publicly publish one party's obligation to perform an action so that party cannot repudiate its obligation to perform the action. Thus, only a previously-agreed upon portion of the content of the data such as the one party's obligation to perform an action may be publicly published.

Accordingly, the invention has been described with some degree of particularity directed to the exemplary embodiments of the invention. It should be appreciated though that modifications or changes may be made to the exemplary embodiments of the present invention without departing from the inventive concepts contained herein.

What is claimed is:

1. A system for publicly certifying data, comprising:
a first party having a public key and a private key, the first party's public key stored on a key registry and the first party's public key verifies a data set signed by the first party's private key;
a second party having a public key and a private key, the second party's public key stored on the key registry and the second party's public key verifies a data set signed by the second party's private key;
a first data set having an attribute, the first party signs the first data set with the first party's private key and sends the data to the second party, the second party verifies the first data set signed by the first party's private key using the first party's public key from the key registry, and the second party verifies the first data set's attribute;
wherein the second party signs the first party's private key signature of the first data set with the second party's private key and sends the first data set to the first party, the first party verifies the signature created by the second party's private key using the second party's public key from the key registry, and the first party verifies the first data set's attribute; and
a token registry verifies the first data set signed by the first party's private key using the first party's public key from the key registry and verifies the signature of the first data set signed by the second party's private key using the second party's public key from the key registry, the token registry verifies the first data set's attribute, the token registry publicly publishes the signed first data set's attribute such that the first and second parties cannot dispute the first data set's attribute.

2. The system of claim 1, further comprising:
a second data set having an attribute, the second party verifies the second data set's attribute when verifying the first data set's attribute, and the first party verifies the second data set's attribute when verifying the first data set's attribute.

3. The system of claim 2, further comprising:
a second token registry verifies the second data set signed by the first party's private key using the first party's public key from the key registry and verifies the second data set signed by the second party's private key using the second party's public key from the key registry, wherein the second token registry verifies the second data set's attribute, and the second token registry publicly publishes the signed second data set's attribute such that the first and second parties cannot dispute the second data set's attribute.

4. The system of claim 1, wherein the first data set is a digital token.

5. The system of claim 2, wherein the second data set is a transaction entry transferring ownership of the first data set from the first party to the second party.

6. The system of claim 1, wherein the token registry verifies the first data set's attribute by comparing data from the first party and data from the second party.

7. The system of claim 1, further comprising:
a first electronic device operated by the first party, the first electronic device having a non-transitory computer-readable storage medium that is configured to store the first party's private key; and
a second electronic device operated by the second party, the second electronic device having a non-transitory computer-readable storage medium that is configured to store the second party's private key.

8. A system for publicly certifying data, comprising:
a first party having a public key and a private key, the first party's public key stored on a key registry and the first party's public key verifies a signature by the first party's private key;
a second party having a public key and a private key, the second party's public key stored on the key registry and the second party's public key verifies a signature by the second party's private key;
a data set having an attribute, the first party signs the data set with the first party's private key and sends the data set to the second party, the second party verifies the signature by the first party's private key using the first party's public key from the key registry, and the second party verifies the data set's attribute, the second party signs the first party's private key signature of the data set with the second party's private key and sends the data set to a token registry; and
wherein the token registry verifies the signature by the first party's private key using the first party's public key from the key registry and verifies the signature by the second party's private key using the second party's public key from the key registry, and wherein upon receiving a command from the second party the token registry publicly publishes the signed data set's attribute such that the first and second parties cannot dispute the data set's attribute.

9. The system of claim 8, wherein the data set is a digital token.

10. The system of claim 8, wherein the token registry verifies the data set's attribute by comparing data from the first party and data from the second party.

11. The system of claim 8, further comprising:
a first electronic device operated by the first party, the first electronic device having a non-transitory computer-readable storage medium that is configured to store the first party's private key; and
a second electronic device operated by the second party, the second electronic device having a non-transitory computer-readable storage medium that is configured to store the second party's private key.

12. A method for publicly certifying data using at least one electronic device, comprising:
providing a first public key and a first private key, the first public key stored on a key registry and the first public key verifies a data set signed by the first private key;
providing a second public key and a second private key, the second public key stored on the key registry and the second public key verifies a data set signed by the second private key;
signing a first data set having an attribute with the first private key;
verifying the signature by the first private key using the first public key and verifying the first data set's attribute;
signing the first data set with the second private key;
verifying the signature by the second private key using the second public key and verifying the first data set's attribute;
sending the first data set over a network to a token registry that verifies the signature by the first private key using the first public key from the key registry, verifies the signature by the second private key using the second public key from the key registry, and verifies the first data set's attribute; and
publishing, publicly by the token registry, the signed first data set's attribute such that the first data set's attribute cannot be disputed.

13. The method of claim 12, further comprising:
verifying a second data set's attribute when verifying the signature by the first private key using the first public key; and
verifying the second data set's attribute when verifying the signature by the second private key using the second public key.

14. The method of claim 13, further comprising:
providing a second token registry that verifies the signature by the first private key using the first public key from the key registry and verifies the signature by the second private key using the second public key from the key registry, and the second token registry verifies the second data set's attribute, the second token registry publicly publishes the signed second data set's attribute such that the second data set's attribute cannot be disputed.

15. The method of claim 12, wherein the first data set is a digital token.

16. The method of claim 13, wherein the second data set is a transaction entry transferring ownership of the first data set from a first electronic device to a second electronic device.

17. The method of claim 12, wherein the token registry verifies the first data set's attribute by comparing data from a first electronic device and data from a second electronic device.

18. A method for publicly certifying data using at least one electronic device, comprising:
providing a first party having a public key and a private key, the first party's public key stored on a key registry and the first party's public key verifies a signature by the first party's private key;
providing a second party having a public key and a private key, the second party's public key stored on the key registry and the second party's public key verifies a signature by the second party's private key;
signing a data set having an attribute with the first party's private key and sending the data set from the first party to the second party;
verifying, by the second party, the signature by the first party's private key using the first party's public key and verifying the data set's attribute;
signing the data set with the second party's private key and sending the data set from the second party to a token registry;
verifying, by the token registry, the signature by the first party's private key using the first party's public key from the key registry, the signature by the second party's private key using the second party's public key from the key registry, and the data set's attribute; and
publishing, publicly by the token registry and after receiving a command from the second party, the signed data set's attribute such that the first and second parties cannot dispute the data set's attribute.

19. The method of claim 18, wherein the data set is a digital token.

20. The method of claim 18, wherein the token registry verifies the data set's attribute by comparing data from the first party and data from the second party.
